(19) United States
(12) Patent Application Publication
(10) Pub. No.: US 2008/0266914 A1
(43) Pub. Date: Oct. 30, 2008

(54) PASSIVE, BACKSCATTER-BASED TRANSPONDER

(76) Inventor: Martin Fischer, Pfedelbach (DE)

Correspondence Address: Muncy, Geissler, Olds & Lowe, PLLC, P.O. BOX 1364, FAIRFAX, VA, 22038-1364, US

(21) Appl. No.: 12/109,303

(22) Filed: Apr. 24, 2008

Related U.S. Application Data
(60) Provisional application No. 60/924,018, filed on Apr. 26, 2007.

(30) Foreign Application Priority Data
Apr. 24, 2007 (DE) DE 102007020318.9
Mar. 5, 2008 (DE) DE 102008013718.9

(51) Int. Cl. H02M 7/00

(52) U.S. Cl. 363/61

(57) ABSTRACT

A passive, backscatter-based transponder is provided that includes a rectifier that generates an output DC voltage from an input AC voltage for the voltage supply of the transponder, whereby the rectifier includes a first rectifier unit and at least one second rectifier unit. The first rectifier unit and the second rectifier unit are connected in parallel and dimensioned for operation in an identical frequency range.

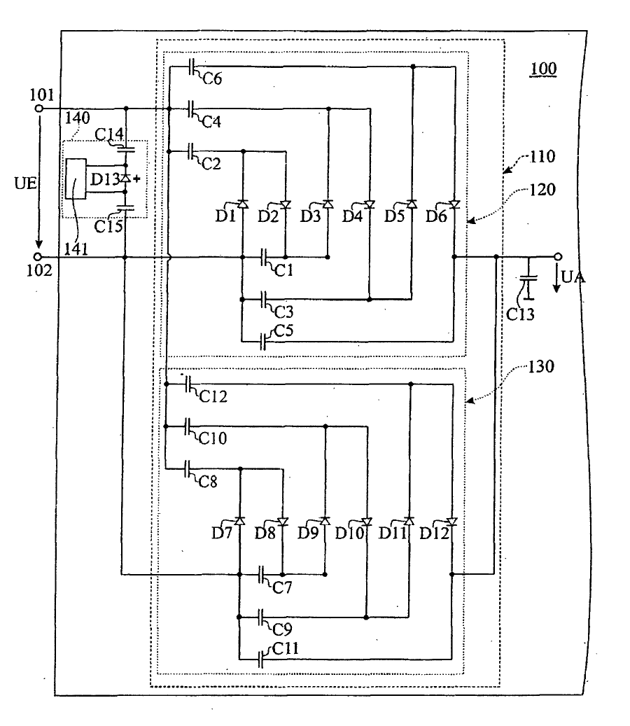

This nonprovisional application claims priority to German Patent Application Nos. DE102007020318.9, which was filed in Germany on Apr. 24, 2007, and DE102008013718, which was filed in Germany on Mar. 5, 2008; and to U.S. Provisional Application No. 60/924,018, which was filed on Apr. 26, 2007, and which are all herein incorporated by reference.

### BACKGROUND OF THE INVENTION

1. Field of the Invention

The invention relates to a passive, backscatter-based transponder.

2. Description of the Background Art

Contactless identification systems or so-called radio-frequency-identification (RFID) systems typically include a base station or a reading device or a reading unit and a plurality of transponders or remote sensors. The transponders or their transmitting and receiving devices typically do not have an active transmitter for data transmission to the base station. Such inactive systems are called passive systems when they do not have their own power supply and semipassive systems when they have their own power supply. Passive transponders draw the power necessary for their supply from the electromagnetic field emitted by the base station.

So-called backscatter coupling is employed, as a rule, for data transmission from a transponder to a base station with UHF or microwaves in the far field of the base station. To that end, the base station emits electromagnetic carrier waves or a carrier signal, which is modulated and reflected by the transmitting and receiving device of the transponder by means of a subcarrier modulation process in accordance with the data to be transmitted to the base station. Amplitude modulation and phase modulation are the typical modulation processes for this purpose.

In the case of passive transponders, a rectifier is typically looped with its input terminals between the terminals for an antenna of the transponder. The rectifier generates an output direct (DC) voltage from an alternating (AC) voltage applied at the antenna terminals for the voltage supply of the transponder.

### SUMMARY OF THE INVENTION

It is therefore an object of the invention to provide a transponder with a rectifier that has an advantageous input impedance and a high reliability.

The passive, backscatter-based transponder, according to an embodiment, comprises a rectifier that generates an output DC voltage from an input AC voltage for the voltage supply of the transponder. The rectifier comprises a first rectifier unit and at least one second rectifier unit, whereby the first rectifier unit and the second rectifier unit are connected in parallel. The first rectifier unit and the second rectifier unit are dimensioned or formed for operation within a substantially identical frequency range. Due to the parallel connection of the rectifier units, the real part of the input impedance of the rectifier declines, because each rectifier unit must supply only one part of the entire output current to be provided by the rectifier. This reduction of the real part of the input impedance increases the signal quality of the modulated signal during modulation of the signal backscattered by the transponder, because the impedance changes more greatly during a modulation relative to the input impedance. Because the rectifier has at least two rectifier units, the rectifier is at least still conditionally operational also during failure of a rectifier unit, as a result of which its reliability increases.

In an embodiment, the first rectifier unit comprises a voltage multiplier circuit, which generates a first part of the output DC voltage from the input AC voltage. The second rectifier unit comprises a voltage multiplier circuit, which generates a second part of the output DC voltage from the input AC voltage, whereby the first and the second part are superimposed to generate the output direct voltage.

In an embodiment, the voltage multiplier circuit of the first rectifier unit and the voltage multiplier circuit of the second rectifier unit each have n voltage multiplier stages, where n is a whole number, with 0<n<∞. Two rectifier units are provided preferably, each of which have three voltage multiplier stages; i.e., n equals 3. The voltage multiplier circuit of the first rectifier unit or of the second rectifier unit can be a voltage multiplier circuit known per se, for example, a so-called Villard cascade. The Villard cascade is also called a high-voltage cascade or Cockcroft-Walton generator and is a circuit that generates a high DC voltage by multiplying and rectifying an AC voltage. It is based on the Villard circuit, which is connected (cascaded) repeatedly one behind another for this purpose. Alternatively, other cascaded circuits can also be used for voltage multiplication.

In an embodiment, a modulation device is provided formed for phase modulation and/or for amplitude modulation of signals to be backscattered. Preferably, the modulation device has a varactor diode for phase modulation. By means of the reduction of the real part of the input impedance, due to the parallel connection of rectifier units as taught by the invention, the signal quality of the modulated signal increases during modulation of the signal backscattered by the transponder, because the impedance changes more greatly during a modulation relative to the input impedance. Consequently, a change in capacitance of the varactor diode due to the smaller real part and a constant imaginary part of the input impedance of the rectifier causes a greater phase change compared with a conventional rectifier. Preferably, both the first rectifier unit and the second rectifier unit, particularly at its input, are electrically coupled or connected via capacitors to the varactor diode.

In an embodiment, the first rectifier unit and the second rectifier unit are constructed structurally identical.

In an embodiment, the first rectifier unit and the second rectifier unit are dimensioned for operation in the UHF frequency range. The UHF frequency range in this case comprises frequencies in a range between 300 MHz and 6 GHz, particularly between 300 MHz and 3 GHz.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, IS not limitive of the present invention, and wherein the single FIGURE illustrates a transponder according to an embodiment of the present invention.

### DETAILED DESCRIPTION

The FIGURE shows a passive, backscatter-based transponder 100 with antenna terminals 101 and 102 for connecting a conventional antenna, which is not shown, a rectifier 110 for generating an output DC voltage UA from an input AC voltage UE, which is generated by the antenna and applied at antenna terminals 101 and 102, and a modulation device 140.

Rectifier 110 comprises a first rectifier unit 120 and a second rectifier unit 130, whereby the first rectifier unit 120 and the second rectifier unit 130 are connected in parallel and in each case are dimensioned identical for operation in the UHF frequency range. The first rectifier unit 120 comprises a voltage multiplier circuit with three voltage multiplier stages and the second rectifier unit 130 comprises a voltage multiplier circuit with three voltage multiplier stages, whereby rectifier units 120 and 130 are constructed identical or have an identical structure.

The voltage multiplier circuits of rectifier units 120 and 130 are connected with their respective input terminals to antenna terminals 101 and 102. The voltage multiplier circuit of the first rectifier unit 120 generates a first part of the output DC voltage UA from the input AC voltage UE and the voltage multiplier circuit of the second rectifier unit 130 generates a second part of the output DC voltage UA from the input AC voltage UE, whereby the first and the second parts are superimposed to generate the output DC voltage UA.

The first voltage multiplier stage of the voltage multiplier circuit of first rectifier unit 120 comprises diodes D1 and D2 and capacitors C1 and C2, whereby a terminal of capacitor C2 is connected to the one antenna terminal 101, the other terminal of capacitor C2 is connected to the cathode of diode D1 and the anode of diode D2, the other antenna terminal 102 is connected to the anode of diode D1 and a terminal of capacitor C1, and the other terminal of capacitor C1 is connected to the cathode of diode D2.

The second voltage multiplier stage of the voltage multiplier circuit of first rectifier unit 120 comprises diodes D3 and D4 and capacitors C3 and C4, whereby a terminal of capacitor C4 is connected to the one antenna terminal 101, the other terminal of capacitor C4 is connected to the cathode of diode D3 and the anode of diode D4, the other antenna terminal 102 is connected to a terminal of capacitor C3, the other terminal of capacitor C3 is connected to the cathode of diode D4, and the cathode of diode D2 and the other terminal of capacitor C1 of the first voltage multiplier stage are connected to the anode of diode D3.

The third voltage multiplier stage of the voltage multiplier circuit of first rectifier unit 120 comprises diodes D5 and D6 and capacitors C5 and C6, whereby a terminal of capacitor C6 is connected to the one antenna terminal 101, the other terminal of capacitor C6 is connected to the cathode of diode D5 and the anode of diode D6, the other antenna terminal 102 is connected to a terminal of capacitor C5, the other terminal of capacitor C5 is connected to the cathode of diode D6, and the cathode of diode D4 and the other terminal of capacitor C3 of the second voltage multiplier stage are connected to the anode of diode D5. The first part of the output voltage UA is output to a connection node of the cathode of diode D6 and the other terminal of capacitor C5 and smoothed by a smoothing capacitor C13.

The first voltage multiplier stage of the voltage multiplier circuit of the second rectifier unit 130 comprises diodes D7 and D8 and capacitors C7 and C8, whereby a terminal of capacitor C8 is connected to the one antenna terminal 101, the other terminal of capacitor C8 is connected to the cathode of diode D7 and the anode of diode D8, the other antenna terminal 102 is connected to the anode of diode D7 and a terminal of capacitor C7, and the other terminal of capacitor C7 is connected to the cathode of diode D8.

The second voltage multiplier stage of the voltage multiplier circuit of the second rectifier unit 130 comprises diodes D9 and D10 and capacitors C9 and C10, whereby a terminal of capacitor C10 is connected to the one antenna terminal 101, the other terminal of capacitor C10 is connected to the cathode of diode D9 and the anode of diode D10, the other antenna terminal 102 is connected to a terminal of capacitor C9, the other terminal of capacitor C9 is connected to the cathode of diode D10, and the cathode of diode D8 and the other terminal of capacitor C7 of the first voltage multiplier stage are connected to the anode of diode D9.

The third voltage multiplier stage of the voltage multiplier circuit of the second rectifier unit 130 comprises diodes D11 and D12 and capacitors C11 and C12, whereby a terminal of capacitor C12 is connected to the one antenna terminal 101, the other terminal of capacitor C12 is connected to the cathode of diode D11 and the anode of diode D12, the other antenna terminal 102 is connected to a terminal of capacitor C11, the other terminal of capacitor C11 is connected to the cathode of diode D12, and the cathode of diode D10 and the other terminal of capacitor C9 of the second voltage multiplier stage are connected to the anode of diode D11. The second part of the output voltage UA is output to a connection node of the cathode of diode D12 and the other terminal of capacitor C11 and smoothed by the smoothing capacitor C13.

Modulation device 140 for phase modulation of signals to be backscattered comprises two blocking capacitors C14 and C15, a varactor diode D13, and a modulation control device 141, which depending on the data to be backscattered generates a control voltage for varactor diode D13. The first rectifier unit 120 and second rectifier unit 130 are electrically coupled to varactor diode D13 at their respective inputs via blocking capacitors C14 and C15.

Based on the parallel circuit of rectifier units 120 and 130, the output current to be supplied per rectifier unit 120 or 130 is halved compared with a conventional rectifier, in which instead of the shown two rectifier units 120 and 130 with three voltage multiplier stages each, only one rectifier unit is provided with a total of six cascaded, i.e., connected in series, voltage multiplier stages. This has the effect that the real part of the input impedance of rectifier 110 is halved approximately compared with the conventional rectifier. Because the number of the employed diodes remains constant, the total capacity and thereby the imaginary part of the input impedance also remain constant compared with the conventional case. Because of the approximately halved real part of the input impedance, virtually a doubling of a phase change of the backscattered, phase-modulated signal is achieved, as a result of which the signal quality of the backscattered, phase-modulated signal increases considerably, as a result of which, for example, a bit error rate can be significantly reduced.

The efficiency of the rectifier can be increased in addition depending on the choice of employed diodes.

Another advantage is the increased redundancy, because the entire rectifier does not fail with the failure of one diode but only one of the two rectifier units.

It is understood that instead of the shown two rectifier units, three or more than three rectifier units can also be used.

Instead of the shown voltage multiplier circuits of the rectifier units, alternative voltage multiplier circuits can also be used, for example, Villard cascades.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A passive, backscatter-based transponder comprising:
a rectifier that generates an output DC voltage from an input AC voltage for the voltage supply of the transponder, the rectifier comprising:
a first rectifier unit; and
at least one second rectifier unit, the first rectifier unit and the second rectifier unit being connected in parallel,
wherein the first rectifier unit and the second rectifier unit are dimensioned for operation in a substantially identical frequency range.

2. The passive, backscatter-based transponder according to claim 1, wherein the first rectifier unit comprises a voltage multiplier circuit, which generates a first part of the output DC voltage from the input AC voltage, and wherein the second rectifier unit comprises a voltage multiplier circuit, which generates a second part of the output DC voltage from the input AC voltage.

3. The passive, backscatter-based transponder according to claim 2, wherein the voltage multiplier circuit of the first rectifier unit and the voltage multiplier circuit of the second rectifier unit each have n voltage multiplier stages, where n is a whole number, with 0<n<∞.

4. The passive, backscatter-based transponder according to claim 2, wherein two rectifier units are provided, each of which having three voltage multiplier stages.

5. The passive, backscatter-based transponder according to claim 1, further comprising a modulation device formed for modulating the signals to be backscattered.

6. The passive, backscatter-based transponder according to claim 5, wherein the modulation device has a varactor diode for phase modulation.

7. The passive, backscatter-based transponder according to claim 6, wherein the first rectifier unit and the second rectifier unit are electrically coupled via capacitors to the varactor diode.

8. The passive, backscatter-based transponder according to claim 1, wherein the first rectifier unit and the second rectifier unit are constructed substantially identical.

9. The passive, backscatter-based transponder according to claim 1, wherein the first rectifier unit and the second rectifier unit operate in the UHF frequency range.
